(19) United States
(12) Patent Application Publication
(10) Pub. No.: US 2010/0224353 A1
(43) Pub. Date: Sep. 9, 2010

(54) METHODS AND APPARATUS INVOLVING COOLING FINS

(75) Inventors: JONATHAN DWIGHT BERRY, Simpsonville, SC (US); ARTHUR SAMUEL PECK, Greenville, SC (US)

Correspondence Address: CANTOR COLBURN, LLP, 20 Church Street, 22nd Floor, Hartford, CT, 06103, US

(73) Assignee: General Electric Company, Schenectady, NY (US)

(21) Appl. No.: 12/398,596

(22) Filed: Mar. 5, 2009

(51) Int. Cl. F28F 7/00; B23P 15/26

(52) U.S. Cl. 165/185; 29/890.054

(57) ABSTRACT

A fin apparatus including a corrugated strip of material having, a first lower planar surface, a second lower planar surface, a first upper planar surface corresponding to the first lower planar surface and the second lower planar surface, wherein the first lower planar surface and the second lower planar surface are operative to be attached to a surface of a component, and a first fin portion connecting the first lower planar surface to the first upper planar surface.

### BACKGROUND OF THE INVENTION

The subject matter disclosed herein relates to cooling fins and methods involving fabricating cooling fins.

Mechanical equipment such as, for example, turbine engines include a variety of air-cooled components. One method for improving the cooling effects of air is using cooling fins to direct the cooling airflow, and to provide additional surface area for convection.

Many air-cooled components are irregularly shaped; and forming and attaching fins for cooling on irregular shaped components may be difficult or expensive. A method and apparatus for effectively and efficiently forming and attaching cooling fins for air cooled components is desired.

### BRIEF DESCRIPTION OF THE INVENTION

According to one aspect of the invention, a fin apparatus including a corrugated strip of material having, a first lower planar surface, a second lower planar surface, a first upper planar surface corresponding to the first lower planar surface and the second lower planar surface, wherein the first lower planar surface and the second lower planar surface are operative to be attached to a surface of a component, and a first fin portion connecting the first lower planar surface to the first upper planar surface.

According to another aspect of the invention, a method for fabricating a fin assembly, the method comprising, identifying a surface of a component for cooling, forming a corrugated strip of material having a first lower planar surface, a second lower planar surface, a first upper planar surface corresponding to the first lower planar surface and the second lower planar surface, and a first fin portion connecting the first lower planar surface to the first upper planar surface, attaching the first lower planar surface to the surface of a component, and attaching the second lower planar surface to the surface of the component.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an exemplary embodiment of a cooling fin assembly.

FIG. 2 is a side cut-away view of an exemplary embodiment of the cooling fin apparatus and the surface component of FIG. 1.

FIG. 3 is a side cut-away view of an alternate exemplary embodiment of a cooling fin apparatus.

FIG. 4 is a perspective view of another alternate embodiment of a cooling fin apparatus.

FIG. 5 is a top view of the cooling fin apparatus of FIG. 4.

FIG. 6 is side view of the cooling fin apparatus of FIG. 4.

FIG. 7 is a top view of an exemplary arrangement of the cooling fin apparatus of FIG. 4.

The detailed description explains embodiments of the invention, together with advantages and features, by way of example with reference to the drawings.

### DETAILED DESCRIPTION OF THE INVENTION

Components in turbine engines are often air cooled. The cooling air often flows at a high velocity and may result in inefficient flow patterns that are insufficient to cool hot portions of a particular component. Cooling fins may be added to improve the cooling effects of the cooling air by, for example, disrupting undesirable boundary layers, increasing the cooling air turbulence, and adding additional surface area to a component to increase heat transfer. Previous methods for fabricating cooling fins included forming the fins as part of the component in a casting process. The cast fins increase the cost of fabricating the component and do not allow for changing the location of fins if desired. Other methods include attaching individual fins to a surface of a component. Attaching individual fins is costly and time consuming. A method and apparatus that allows multiple fins to be easily fabricated and attached to the surface of a component is described below.

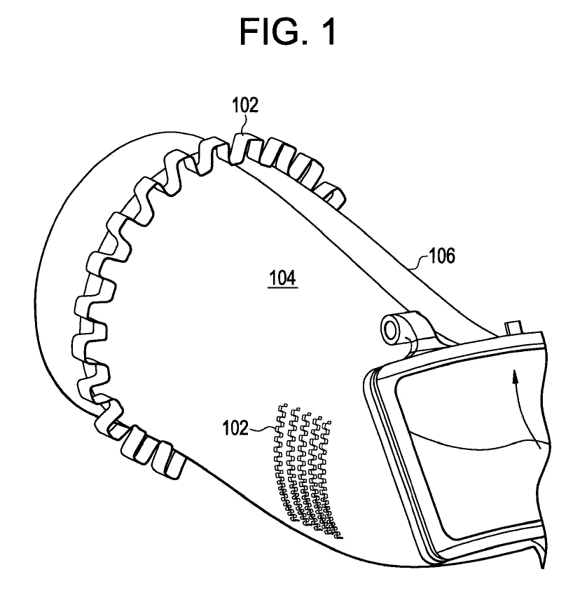

FIG. 1 illustrates a perspective view of an exemplary embodiment of a cooling fin apparatus 102 attached to a surface 104 of a component 106. In the illustrated embodiment, the surface 104 is an outer surface of an air cooled turbine component (e.g., a transition portion or combustion liner). In operation, the component is cooled by a flow of air along the surface 104. The cooling fin apparatus 102 is a strip of corrugated flexible material such as, for example, steel, titanium, aluminum, super allow, or other type of suitable material. The cooling fin apparatus 102 is attached to the surface 104 using, for example, welding or brazing methods. The cooling fin apparatus 102 may be dimensioned and attached to the surface 104 such that the cooling fin apparatus 102 surrounds an outer perimeter of the surface 104, or may be applied to particular portions of the surface 104 that are identified for cooling.

The flexibility of the cooling fin apparatus 102 allows the cooling fin apparatus 102 to be bent to conform to curved profiles of the surface 104. The cooling fin apparatus 102 may be bent or twisted to make contact with the surface 104 along various points of the surface 104.

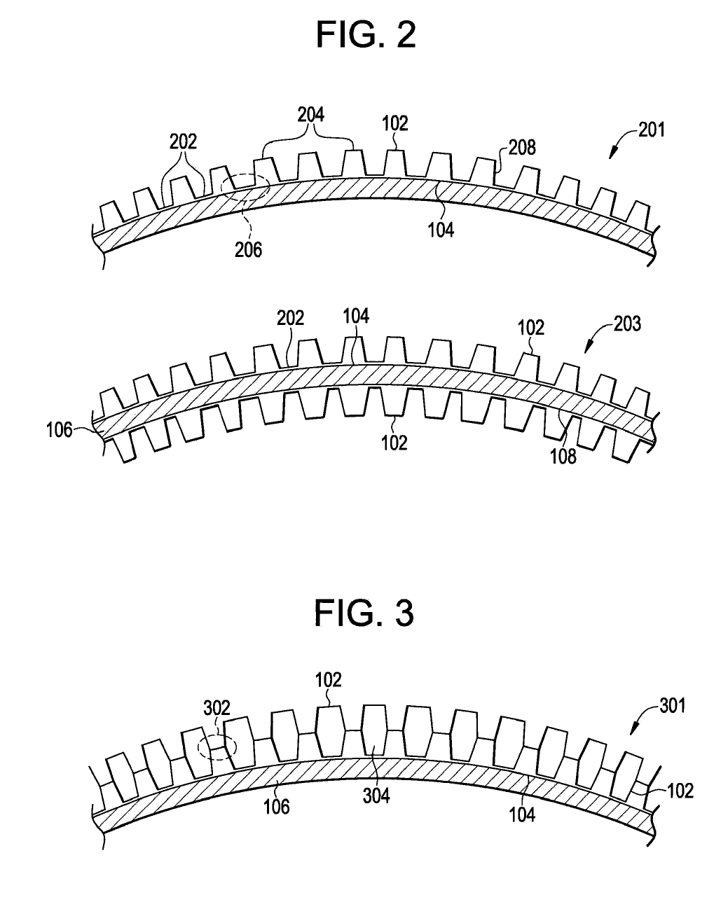

FIG. 2 illustrates a side cut-away view of an exemplary embodiment 201 of the cooling fin apparatus 102 and the surface component 106. The cooling fin apparatus 102 includes a plurality of lower planar surfaces 202 and upper planar surfaces 204 connected by fin portions 208. The lower planar surfaces 202 are attached to the surface 104 in the regions 206. The lower planar surfaces 202 may be attached using, for example, welds, or brazing. The exemplary embodiment 203 is similar to the exemplary embodiment 201, and includes a second cooling fin apparatus 102 attached to an inner surface 108 of the component 106.

FIG. 3 illustrates an alternate exemplary embodiment 301 includes a first cooling fin apparatus 102 attached to the surface 104 as described above. The exemplary embodiment 301 has a second cooling fin apparatus 102 attached to the first cooling fin apparatus 102. The second cooling fin apparatus 102 may be attached to the first cooling fin apparatus 102 by aligning the upper planar surface 204 (of FIG. 2) of the first cooling fin apparatus 102 with the lower planar surface 202 of the second planar surface 102 and attaching the surfaces in region 302. The exemplary embodiment 301 results in cavities 304 defined by the first cooling fin apparatus 102 and the second cooling fin apparatus.

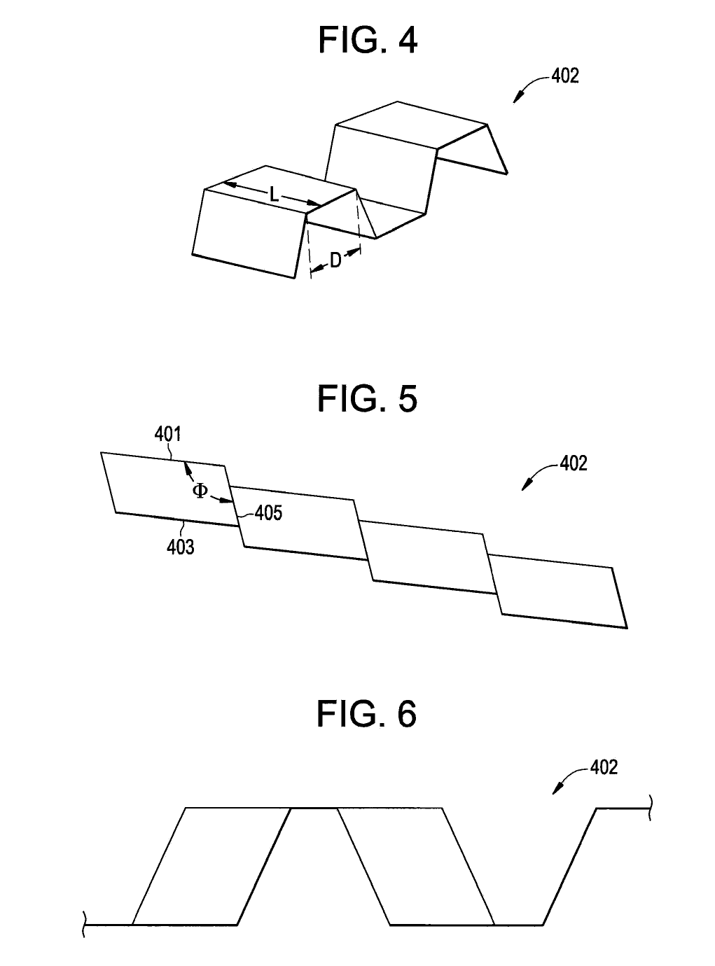

FIG. 4 illustrates a perspective view of an alternate embodiment of a cooling fin apparatus 402. The cooling fin apparatus 402 is similar to the cooling fins described above however, the bends forming the corrugated cooling fin apparatus 402 are at oblique angles to the longitudinal edges of the cooling fin apparatus 402. FIG. 4 includes a hydraulic diameter (Dₕ)=(4×cross sectional area/wetted perimeter) or roughly estimated as dimension (D) and a length dimension (L). The dimensions may be defined in any of the embodiments described above. The illustrated embodiment includes dimensions in a ratio of L/D<2. The ratio improves performance when used on non-cylindrical and non-uniform surfaces. FIG. 5 illustrates a top view of the cooling fin apparatus 402 having a first longitudinal edge 401 and a second longitudinal edge 403. The bend 405 is shown at an oblique angle (Φ) to the first longitudinal edge 401 and a second longitudinal edge 403. FIG. 6 illustrates a side view of the cooling fin apparatus 402. Forming the corrugated cooling fin apparatus 402 with oblique angles allows the fin portions to direct air flow at an angle off of a perpendicular axis of the cooling fin apparatus 402.

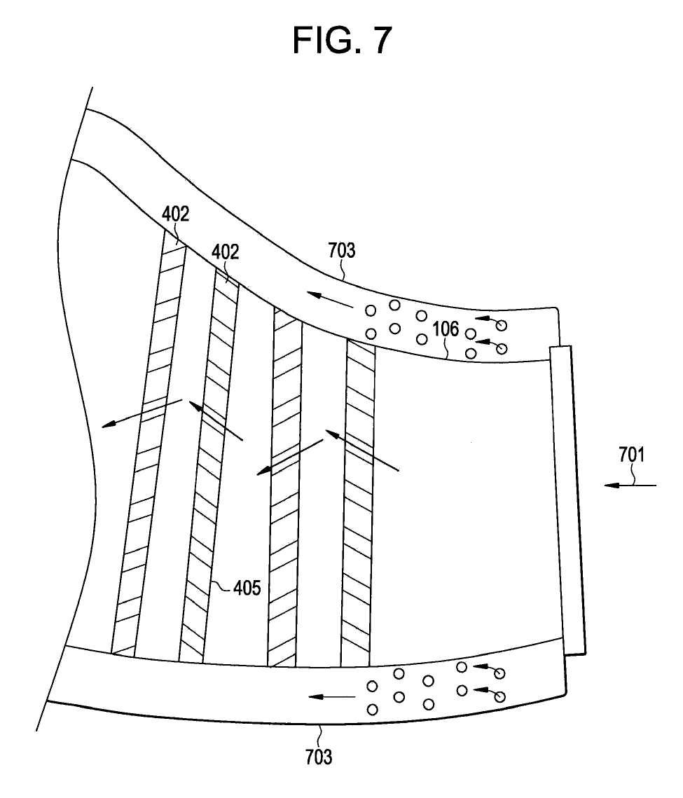

FIG. 7 illustrates a top view of an example of a plurality of cooling fin apparatus 402 attached to the component 106. The cooling fin apparatus 402 are orientated such that the fins portions 405 change the angle of flow of cooling air illustrated with arrows 701. Cooling air may be emitted from an impingement shield portion 703. Changing the angle of the flow of the cooling air 701 increases the efficiency of the cooling effects of the cooling air 701. For example, the angled fins impart a tangential component to the hot flow of the cooling air, causing the heated air to move radially outward from the surface of the component 106. The movement of the heated air outward causes cooler air to flow inward towards the hot surface of the component 106.

The embodiments of cooling fin apparatus described above may be formed from bending a strip of flexible material to form a corrugated cooling fin apparatus. The bends may be made at a normal or oblique angle to the longitudinal edges of the strip. Once a surface of a component is identified for cooling by, for example, experimentation and operational testing, the corrugated cooling fin apparatus may be attached to the surface of a component using a variety of methods. The flexibility of the cooling fin apparatus allows the apparatus to be bent to contact irregular and curved surfaces. For example, a selection of lower planar surfaces of the corrugated cooling fin apparatus may fastened to the surface by a resistive weld or similar method. The remaining lower planar surfaces may then be attached to the surface using a brazing method such as, for example, brazing tape, paste, or powder. Other attachment methods may include tack welding, or welding each of the lower planar surfaces to the surface of the component.

The apparatus and methods described above offer an efficient and cost effective method for forming and attaching cooling fins to a surface of an air cooled component. The method allows for multiple angled fin surfaces to be attached to a component that may include irregularly shaped surfaces.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fin apparatus including a corrugated strip of material having:
a first lower planar surface;
a second lower planar surface;
a first upper planar surface corresponding to the first lower planar surface and the second lower planar surface, wherein the first lower planar surface and the second lower planar surface are operative to be attached to a surface of a component; and
a first fin portion connecting the first lower planar surface to the first upper planar surface.

2. The fin apparatus of claim 1, wherein the first lower planar surface is partially defined by a first longitudinal edge of the material, a second longitudinal edge of the material, and a first bend in the material.

3. The fin apparatus of claim 1, wherein the first upper planar surface is partially defined by a first longitudinal edge of the material, a second longitudinal edge of the material, a second bend in the material, and a third bend in the material.

4. The fin apparatus of claim 1, wherein the first lower planar surface is attached to the surface of the component with a weld.

5. The fin apparatus of claim 1, therein the second lower planar surface is attached to the surface of the component with a braze.

6. The fin apparatus of claim 1, wherein the corrugated strip of material is flexible.

7. The fin apparatus of claim 2, wherein the first bend is at an oblique angle relative to the first longitudinal edge of the material and the second longitudinal edge of the material.

8. The fin apparatus of claim 3, wherein the second bend is at an oblique angle relative to the first longitudinal edge of the material and the second longitudinal edge of the material.

9. The fin apparatus of claim 1, wherein the first upper planar surface defines a first dimension (D) and a second dimension (L) and L/D<2.

10. A method for fabricating an assembly, the method comprising:
identifying a surface of a component for cooling;
forming a corrugated strip of material having a first lower planar surface, a second lower planar surface, a first upper planar surface corresponding to the first lower planar surface and the second lower planar surface, and a first fin portion connecting the first lower planar surface to the first upper planar surface;
attaching the first lower planar surface to the surface of a component; and
attaching the second lower planar surface to the surface of the component.

11. The method of claim 10, providing the first lower planar surface partially defined by a first longitudinal edge of the material, a second longitudinal edge of the material, and a first bend in the material.

12. The method of claim 10, providing the first upper planar surface partially defined by a first longitudinal edge of the material, a second longitudinal edge of the material, a second bend in the material, and a third bend in the material.

13. The method of claim 10, providing the first lower planar surface attached to the surface of the component with a weld.

14. The method of claim 10, providing the second lower planar surface attached to the surface of the component with a braze.

15. The method of claim 10, wherein the corrugated strip of material is flexible.

16. The method of claim 10, providing the corrugated strip of material including a second fin portion connecting the first upper planar surface to the second lower planar surface.

17. The method of claim 12, providing the first bend at an oblique angle relative to the first longitudinal edge of the material and the second longitudinal edge of the material.

18. The method of claim 10, wherein the component is a transition portion of a turbine.

19. The method of claim 10, wherein the surface of the component is a non-uniform shape.
